(19) United States
(12) Patent Application Publication
(10) Pub. No.: US 2025/0336037 A1
(43) Pub. Date: Oct. 30, 2025

(54) PLANAR PURGE

(71) Applicant: FANUC AMERICA CORPORATION, Rochester Hills, MI (US)

(72) Inventors: Michael Baucum, Rochester Hills, MI (US); Bruce Coldren, West Bloomfield, MI (US); Ganesh Kalbavi, Rochester, MI (US)

(21) Appl. No.: 18/645,823

(22) Filed: Apr. 25, 2024

(51) Int. Cl. G06T 5/50; G06V 10/26; G06V 10/44; G06V 10/60; G06V 20/60

(52) U.S. Cl. CPC G06T 5/50; G06V 10/273; G06V 10/44; G06V 10/60; G06V 20/60; G06T 2207/20021; G06T 2207/20224

(57) ABSTRACT

A method and system for eliminating 2D features from planar surfaces in 2D images. Three digital images are taken, from a single camera at a fixed position, of a subject such as a pallet of boxes. One image (IA) is taken with ambient lighting, one image (I1) has ambient lighting plus a first added light source, and one image (I2) has ambient lighting plus a second added light source. An output image Q is then computed by Q=(I1−IA)/(I2−IA). Subtracting the ambient image removes ambient diffuse and specular reflections. Division eliminates all variations in the output image caused by color. The only variations that remain are those due to the angle between each surface point's normal direction and the direction from the light to that point. The output image Q, devoid of all colors and 2D features, is well suited for computing a robot grasp of an object in the image.

### BACKGROUND

### Field

The present disclosure relates to the field of image analysis and, more particularly, to a method and system for eliminating 2D features from planar surfaces and accentuating 3D features in 2D images, where three images are taken by a fixed camera using different combinations of ambient and supplemental light, and image arithmetic is used to compute an output image which is devoid of 2D features including shading variations due to colors, graphics, markings and tape.

### Discussion of the Related Art

The use of camera images as input to machine control systems is well known, with applications ranging from automotive collision avoidance to industrial robot motion programming. In one common robotic application, a pallet of boxes is provided, and an industrial robot is used to pick one box at a time off of the pallet and place each box in a destination location—such as on a conveyor where the box is taken for further processing. In such depalletizing operations, it is known to use one or more cameras to provide images of the pallet of boxes, and analyze the images to identify corners, edges and sides of boxes. Depalletizing algorithms are then used to select a particular box for the next robotic grasping operation, and the process is repeated until the pallet is empty.

Depending on the nature of the boxes on the pallet, it can be difficult to accurately identify the shapes and sizes of the boxes using known image processing techniques, which include both two dimensional (2D) and three dimensional (3D) methods. 3D methods typically use point cloud data, such as from optical methods such as stereo imaging, structured light, or time of flight, to approximate the three dimensional shape of the surfaces of the object(s) being observed. However, point cloud data may be noisy, often have sparse data point spacing, and may include “drop outs” or areas which are missing surface points. These and other problems with point cloud data make it difficult to accurately determine the shape of the object(s) being observed using 3D image analysis.

Analysis of 2D images to identify objects can also be problematic. Many boxes include text, graphics, color variations, tape and other features on their surfaces which make edge and corner detection using 2D camera images unreliable. If a line or color feature of a box is misidentified as a box edge, this could lead to an attempted robot grasp in an erroneous location, resulting in a failed grasp or a dropped box.

In light of the situation described above, there is a need for an improved image analysis technique which eliminates shading variations due to color and other 2D features from planar surfaces, to improve image-based object identification.

### SUMMARY

In accordance with the teachings of the present disclosure, a technique for eliminating 2D features from planar surfaces in 2D images is provided. The technique includes taking three digital images of a subject such as a palletized stack of boxes. All images are taken from a single camera at a fixed position. One image (IA) is taken with only ambient lighting, one image (I1) has ambient lighting plus a first added light source at a first position, and one image (I2) has ambient lighting plus a second added light source at a second position. An output image Q is then computed using an equation, Q=(I1−IA)/(I2−IA). Subtracting the ambient image removes ambient diffuse and specular reflections. Division eliminates all variations in the output image caused by color. The only variations that remain are those due to the angle between each surface point's normal direction and the direction from the light to that point, and the output image Q is devoid of all color-based shading variations and reflections such as markings, graphics and tape, while retaining all 3D features such as gaps between boxes. The output image Q is particularly well suited for computing a robot grasp of an object in the image.

Additional features of the presently disclosed devices and methods will become apparent from the following description and appended claims, taken in conjunction with the accompanying drawings.

### BRIEF DESCRIPTION OF THE DRAWINGS

FIG. 1 is an image of a collection of boxes on a pallet, illustrating how graphical patterns and colors on boxes can make it difficult to distinguish one box from another in 2D image analysis;

FIG. 2 is an image of a collection of boxes on a pallet, illustrating how tape at box seams, and the resulting reflections, can make it difficult to distinguish one box from another in 2D image analysis;

FIG. 3 is an illustration of the behavior of diffuse and specular reflections from a surface;

FIG. 4 is an illustration of a system for obtaining images of a subject and processing the images to produce an output image which is devoid of shading variations due to 2D features such as colors, graphics and tape, according to an embodiment of the present disclosure;

FIG. 5 is a flowchart diagram of a method for obtaining images of a subject and processing the images to produce an output image which is devoid of shading variations due to 2D features such as colors, graphics and tape, according to an embodiment of the present disclosure;

FIG. 6A is the image of the collection of boxes of FIG. 1, and FIG. 6B is a corresponding output image with planar features purged using the system of FIG. 4 and the method of FIG. 5;

FIG. 7A is the image of the collection of boxes of FIG. 2, and FIG. 7B is a corresponding output image with planar features purged using the system of FIG. 4 and the method of FIG. 5; and

FIG. 8A is an image of a collection of flat packages, and FIG. 8B is a corresponding output image with planar features purged using the system of FIG. 4 and the method of FIG. 5.

### DETAILED DESCRIPTION OF THE EMBODIMENTS

The following discussion of the embodiments of the disclosure directed to a method and system for eliminating 2D features from planar surfaces and accentuating 3D features in 2D images is merely exemplary in nature, and is in no way intended to limit the disclosed devices and techniques or their applications or uses.

It is well known to use camera images and/or sensor data as input to a wide variety of machine control systems. One known application is box depalletizing, where a quantity of boxes on a pallet is presented, and a robot is tasked with grasping the boxes one at a time and moving each box to a secondary location. Both two dimensional (2D) and three dimensional (3D) image and data processing techniques exist and are used to identify individual boxes in the stack as input to the box depalletizing operation. However, these existing techniques, both 2D and 3D, suffer from difficulties in accurately analyzing the images or data.

In 3D techniques using point cloud data, the points in the point cloud may be sparse, and some regions of the point cloud may suffer from “drop out” where data points are missing. Resolution of 3D data can also be problematic, where coarse resolution may lead to erroneous identification of box shapes, and fine resolution can be slow and compute-intensive to process. In 2D image analysis techniques, text, images, color patterns and other 2D features on box surfaces can lead to inaccurate box shape identification, as shown in the following figures and discussed below.

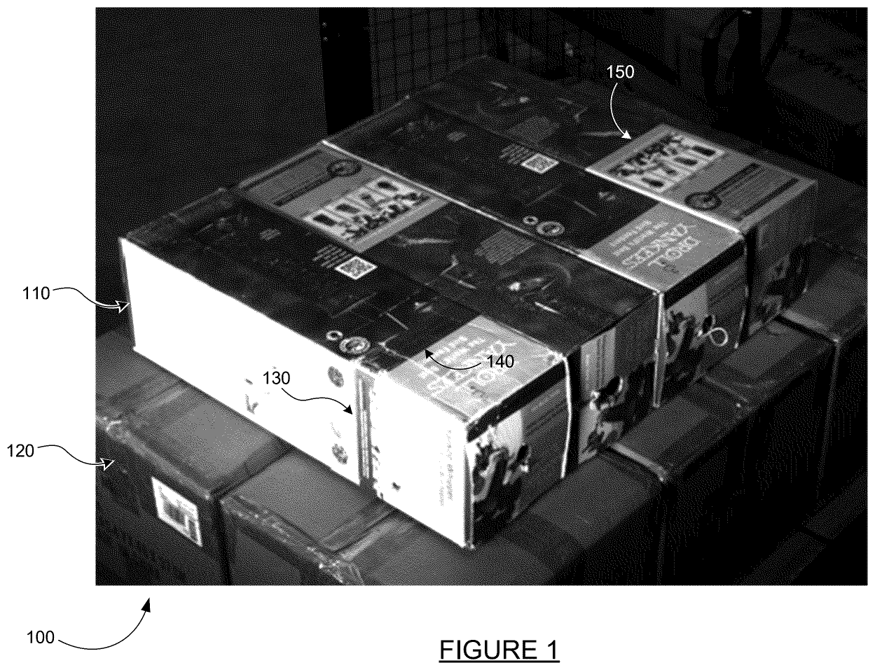

FIG. 1 is an image 100 of a collection of boxes on a pallet, illustrating how graphical patterns and colors on boxes can make it difficult to distinguish one box from another in 2D image analysis. The subject of the image 100 is a pallet stacked with two layers of boxes—including an upper layer 110 of smaller boxes and a lower layer 120 of larger boxes. The boxes in the upper layer 110 include many graphical designs, images and text on their surfaces, which can make it difficult to identify box edges via 2D image analysis. In particular, a dark bar 130 surrounded by lighter areas could be mistaken for a box edge, as could straight-line transitions from a light background to a dark background as indicated at 140 and 150. Several other graphical features, which could easily be mistaken for a box edge in 2D image analysis, are readily noticeable on the boxes in the upper layer 110. Techniques to overcome misidentification of box edges, such as using multiple cameras, can add complexity and have proven only partially effective.

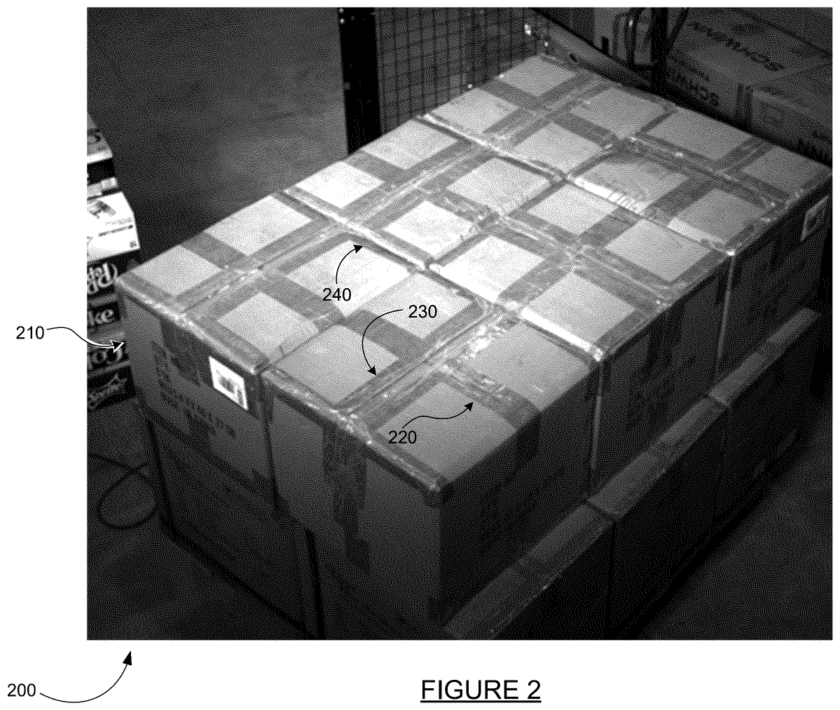

FIG. 2 is an image 200 of a collection of boxes on a pallet, illustrating how tape at box seams, and the resulting reflections, can make it difficult to distinguish one box from another in 2D image analysis. The subject of the image 200 is a pallet stacked with two layers of boxes—including an upper layer 210 which will be the focus of this discussion. The boxes in the upper layer 210 are constructed of plain brown cardboard, with none of the graphical imagery of the boxes in FIG. 1. However, the boxes in the upper layer 210 have transparent tape applied across their faces. A tape strip 220 is placed mostly across a middle portion of cardboard panels on a box, away from edges. A tape strip 230 is placed across flap edges in the middle of a box top. And a tape strip 240 is placed along a top edge of a box to hold down flap edges. Even with transparent tape, any of the tape strips 220, 230 and 240 could be identified as possible box edges using 2D image analysis, because the tape causes an apparent change in “color” (shading or pixel intensity) of the box, and glare in the image adds bright reflections and makes it difficult to determine what the tape is covering.

Both FIGS. 1 and 2 illustrate how 2D features such as graphics and tape on planar surfaces (the tops of boxes) can interfere with the identification of box edges through 2D image analysis. The present disclosure provides a method and system for processing images to purge the 2D features (intensity variations due to color, tape, etc.) and accentuate 3D features (such as true box edges), enabling subsequent image analysis to identify boxes to be performed much more robustly and reliably. Throughout the present disclosure, when a technique is described as “eliminating colors” from the output image, this does not simply mean converting color to grayscale as would be done by a black and white camera. Rather, “elimination of colors” means completely purging all intensity variations from the output image—as if there had been no colors, marking or 2D features on the subject to begin with.

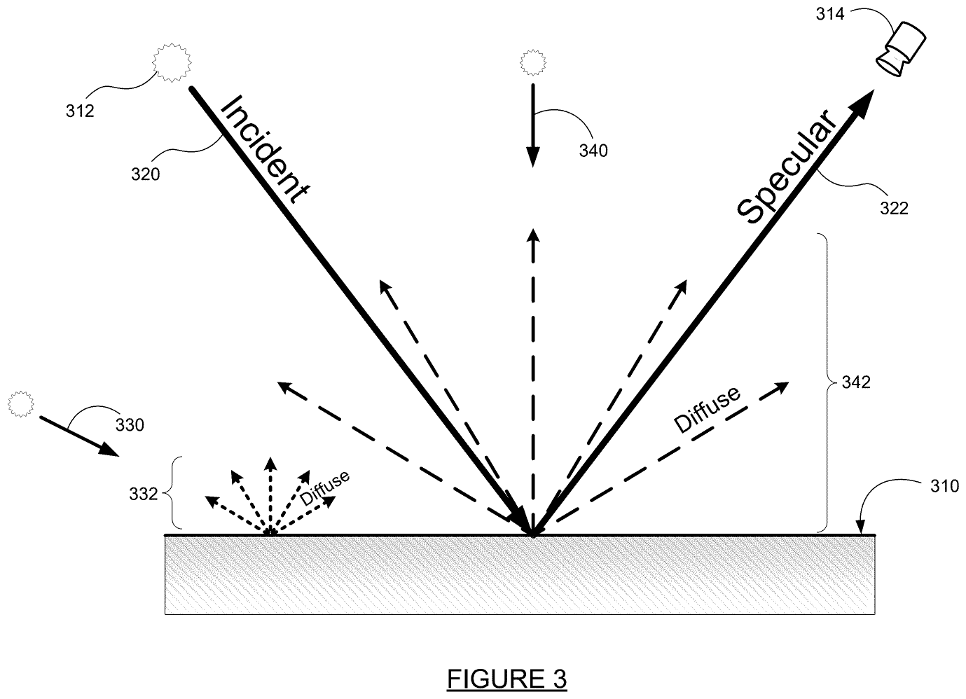

FIG. 3 is an illustration of the behavior of diffuse and specular reflections from a surface 310. Specular reflections (such as glare) are only visible when the reflecting surface's normal vector bisects the vector from the surface to the light source and the vector from the surface to the observer. In other words, if incident light from a source 312 impinges on the surface 310 along a vector 320, then specular reflection will only be visible to an observer 314 which is viewing the surface 310 along a vector 322—where the vector 320 and the vector 322 are symmetrically opposite each other across a surface normal.

Diffuse reflections have the same brightness to an observer no matter from what angle he/she looks at the surface 310. For example, if a light source strikes the surface 310 from a low angle (nearly parallel to the surface) along a vector 330, diffuse reflections of a low brightness or intensity will be visible from any angle relative to the surface 310, as indicated by short-dash arrows 332. If a light source strikes the surface 310 from a high angle (nearly normal to the surface) along a vector 340, diffuse reflections of a high brightness or intensity will be visible from any angle relative to the surface 310, as indicated by long-dash arrows 342.

Most objects show a combination of both specular and diffuse reflections, and this can be problematic to sort out in 2D image analysis. However, the present disclosure provides a technique for capturing multiple images of a subject under particular different lighting conditions and mathematically combining the images in a way that eliminates undesirable reflection characteristics and accentuates desirable ones. This technique is discussed in detail below.

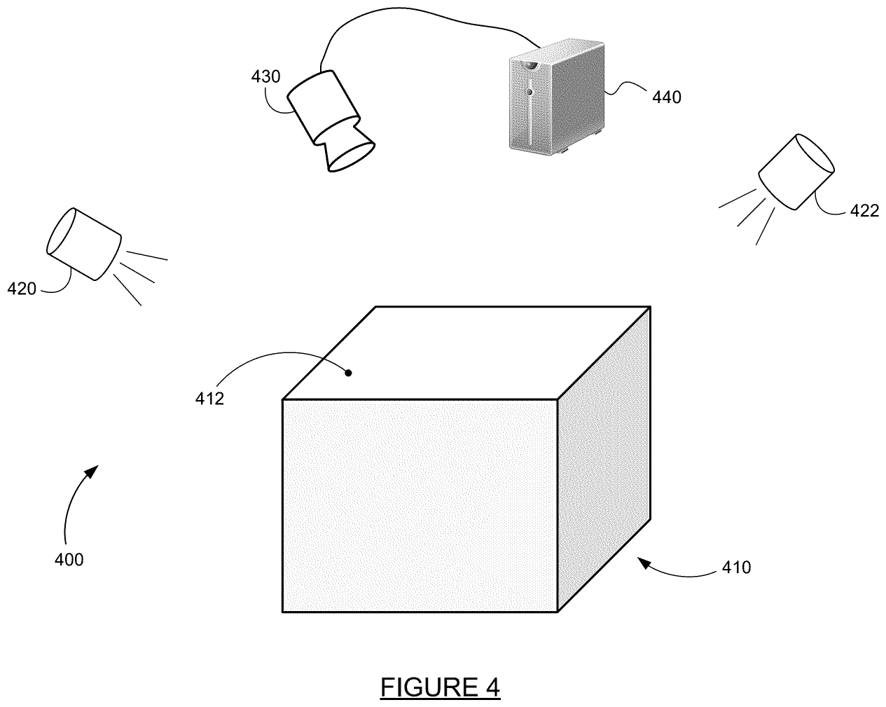

FIG. 4 is an illustration of a system 400 for obtaining images of a subject and processing the images to produce an output image which is devoid of intensity variations due to 2D features such as colors, graphics and tape, according to an embodiment of the present disclosure. A subject 410 is one or more objects which will be represented in images or sensor data. To continue with the example used throughout this disclosure, the subject 410 could be a collection of boxes on a pallet. However, the subject 410 could be a single object such as a box, or any other plurality of objects. The techniques of the present disclosure will work on any embodiment of the subject 410, and work particularly well when the subject 410 has a relatively planar top surface 412, or any other relatively planar surface where 2D features such as colors, graphics and tape exist which need to be removed from an output image.

FIG. 4 describes one embodiment of the disclosed technique in some detail. The example embodiment of FIG. 4 depicts a scenario where the subject 410 has a horizontal top surface 412 for which an image is needed which is devoid of intensity variations due to 2D features. The placement of lights and camera in FIG. 4 are suitable for a top surface imaging scenario. However, the scenario of FIG. 4 is merely an example to illustrate the disclosed technique. Many other imaging scenarios are possible using the same disclosed techniques—such as imaging vertical side surfaces of a subject, imaging surfaces which are at oblique angles relative to vertical and horizontal directions, etc. Some scenarios involve more than one surface being imaged, more than two light sources, and combinations of output images into a composite. These scenarios are discussed further below. Again, FIG. 4 illustrates one specific, non-limiting example.

A first light 420 and a second light 422 are fixed at different locations directed downward at an oblique angle toward the subject 410. The lights 420/422 should not be directed vertically downward onto the horizontal top surface 412, but rather should have an aiming angle which is between vertical and horizontal. In one embodiment, the lights 420/422 have an elevation angle of 25-45° above horizontal; higher or lower elevation angles are also suitable. In a preferred embodiment, the lights 420/422 each have the same elevation angle above horizontal.

The lights 420/422 must be located in different positions from each other, as the intention is to illuminate the subject 410 differently in different images. In one embodiment, the lights 420/422, when viewed from directly above the subject 410, have positions and aiming vectors which are about 90° apart in the top view. However, other relative positional angles are also suitable—including the lights 420/422 being 180° apart in the top view (directly opposite each other). In one embodiment, the lights 420/422 are light emitting diode (LED) lights, although other types of lights are also suitable.

The workspace where the subject 410 is located will typically have sources of ambient light besides the lights 420/422. The ambient light could be, for example, a combination of artificial lighting (such as fluorescent light fixtures in a warehouse) and natural sunlight. The presence and uncontrollability of ambient light is usually unavoidable, and thus the presently disclosed techniques have been developed to acknowledge this fact and compensate for it, as discussed below.

A two-dimensional (2D) sensor 430 is fixed at another location, preferably different from the locations of the lights 420/422, and is configured to capture sensor data or images of the subject 410. In one embodiment, the sensor 430 is a digital camera which takes black and white (grayscale) images of the subject 410, the images having a resolution in a range of 1-5 megapixels. Higher or lower resolutions may also be used. Color images may be used, however, the image arithmetic techniques discussed below operate on pixel intensity values, so grayscale images are suitable. The data provided by the 2D sensor 430 will henceforth be referred to as images; however, it should be understood that the other types of 2D sensors and data could also be used. The top surface 412, which will be compensated in the images to purge 2D features including color effects, must be illuminated by both of the lights 420 and 422, and the surface 412 must of course be within the field of view of the sensor 430.

A computer 440 receives a set of three images from the sensor 430 for the disclosed image analysis technique. The computer 440 may communicate wirelessly with the sensor 430, or via a hard-wire connection. The computer 440 may also control the lights 420/422. After the subject 410 is in position, the computer 440 may control the acquisition of the three images automatically—including capturing an image with ambient light only (which will be known as I_{A}), an image with ambient light plus the light 420 on and the light 422 off (which will be known as I₁), and an image with ambient light plus the light 422 on and the light 420 off (which will be known as I₂).

Following is a discussion of how image arithmetic is used to combine the three images in a particular way in order to purge 2D features and enhance 3D features in the subject 410. Lambert's diffuse reflection law can be written as:

$${I}_{D} = L \cdot {NCI}_{L} \qquad ( 1 )$$

Where I_{D} is the intensity of the diffusely reflected light, I_{L} is the intensity of the incident light (which is assumed to be a point source at infinity), L is the unit vector from the surface to the light, N is the unit normal vector to the surface, and C is the reflectance of the surface (related to the color). It is understood that the Lambert diffuse reflection law assumes that all the light rays emanate from a distant point light source so that they are all parallel to the vector L and all have a constant intensity I_{L} over the camera field of view. Practically, is has been found that the lighting can be made to meet these conditions closely enough that Equation (1) can beneficially be used in the image processing method described below.

Equation (1) can be rewritten to help illustrate the image processing concepts of the present disclosure. The dot product of the vectors L and N is defined as L·N=∥L∥∥N∥ cos θ, where θ is the angle between the surface normal vector and the vector from the surface to the light. Because L and N are unit vectors, ∥L∥ and ∥N∥ are both equal to 1, so L·N=cos θ. Substituting for L·N in Equation (1) yields I_{D}=C I_{L} cos θ. This form of the equation is known as Lambert's cosine law.

Using Lambert's cosine law, the contributions of all ambient light sources to the diffusely reflected light in an image can be defined as:

$${I}_{D A} = {\sum }_{i = 1}^{M} {CI}_{A , i} cos {θ}_{A , i} \qquad ( 2 )$$

Where I_{DA} is the intensity of the diffusely reflected light from all ambient light sources (numbering M), I_{A,i} is the intensity of the incident light from a particular ambient light source i, and θ_{A,i} is the angle between the surface normal vector and the vector from the surface to the particular ambient light source i.

Referring again to Equation (1) rewritten as Lambert's cosine law, the contributions of the supplemental light sources (the lights 420/422) to the diffusely reflected light in images can be defined as:

$${I}_{D 1} = {CI}_{L 1} cos {θ}_{1} \qquad ( 3 )$$

$${I}_{D 2} = {CI}_{L 2} cos {θ}_{2} \qquad ( 4 )$$

Where in Equation (3) I_{D1} is the intensity of the diffusely reflected light from supplemental light source 1 (the light 420), I_{L1} is the intensity of the incident light from supplemental light source 1 (the light 420), and θ₁ is the angle between the surface normal vector and the vector from the surface to supplemental light source 1 (the light 420). Equation (4) is defined similarly for supplemental light source 2 (the light 422).

Using the system 400 of FIG. 4, when an image is taken with one of the supplemental light sources (the light 420 or 422) illuminated, the resulting image includes contributions of diffusely reflected light from both that supplemental light source and ambient lighting. That is,

$${I}_{D 1 , A} = {I}_{D 1} + {I}_{D A} \qquad ( 5 )$$

$${I}_{D 2 , A} = {I}_{D 2} + {I}_{D A} \qquad ( 6 )$$

Where in Equation (5) I_{D1,A} is the intensity of the diffusely reflected light from both supplemental light source 1 (the light 420) and ambient; this (ignoring specular reflection for the moment) is the image I₁ taken using the system 400. Equation (6) is defined similarly for supplemental light source 2 (the light 422), where I_{D2,A} is represented by the image I₂ taken using the system 400.

Because the ambient light sources are essentially uncontrollable and may contain sources of unwanted variation, it is desirable to first subtract ambient light contributions from each of the supplementally lighted images. Rewriting Equations (5) and (6) by rearranging the terms provides the following:

$${I}_{D 1} = {I}_{D 1 , A} - {I}_{D A} \qquad ( 7 )$$

$${I}_{D 2} = {I}_{D 2 , A} - {I}_{D A} \qquad ( 8 )$$

Another objective of the presently disclosed technique is to entirely eliminate intensity variations due to color from an output image, so as to avoid the problems illustrated in FIGS. 1 and 2, where box edges are difficult to identify because of colors and other 2D features on the top surface of the pallet of boxes. An output image Q can be defined as follows:

$$Q = \frac{{I}_{D 1}}{{I}_{D 2}} \qquad ( 9 )$$

Then, substituting Equations (3) and (4) into Equation (9) yields:

$$Q = \frac{{I}_{D 1}}{{I}_{D 2}} = \frac{{CI}_{L 1} cos {θ}_{1}}{{CI}_{L 2} cos {θ}_{2}} \qquad ( 10 )$$

Which simplifies to:

$$Q = \frac{{I}_{L 1} cos {θ}_{1}}{{I}_{L 2} cos {θ}_{2}} \qquad ( 11 )$$

The color component C does not appear in Equation (11), as it has canceled out of the numerator and denominator. Thus, the image division technique of Equations (9)-(11) eliminates color (that is, the pixel intensity variations associated with different colors) from the output image Q.

Assuming that the light intensity values I_{L1} and I_{L2} are constant over the image field of view, Equation (11) can be further reduced to:

$$Q = K \frac{cos {θ}_{1}}{cos {θ}_{2}} \qquad ( 12 )$$

Where K (defined as I_{L1}/I_{L2}) is a constant value. In a preferred embodiment, the the lights 420 and 422 are adjusted to make the value of K close to 1.

Equation (12) clearly shows that the brightness variations among the points in the output image Q are only caused by variations in the relative angles (θ₁ and θ₂) from the normal vector at each point on the surface to the two lights. On flat surfaces the normal vector is constant, so all of the pixels on a given flat surface have the same constant value. Pixels on different flat surfaces have different constant values depending on the normal vector directions of those surfaces.

It is understood that the above equations are all approximations because the light rays from real physical light sources do not all emanate from the same distant point and so are not all parallel and do not all have the same intensity. However in practice it has been found that the approximations are good enough to make the planar purge method useful.

Then, substituting Equations (7) and (8) into Equation (9) yields:

$$Q = \frac{{I}_{D 1}}{{I}_{D 2}} = \frac{{I}_{D 1 , A} - {I}_{D A}}{{I}_{D 2 , A} - {I}_{D A}} \qquad ( 13 )$$

As discussed above, ignoring specular reflection, I_{D1,A} is the image I₁ (ambient plus the light 420) taken using the system 400, I_{D2,A} is the image I₂ (ambient plus the light 422) taken using the system 400, and I_{DA} is the image I_{A} (ambient only) taken using the system 400. Thus, the three images of the subject 410 captured by the sensor 430 can be combined to produce an output image Q which is devoid of color and other 2D features as follows:

$$Q = \frac{{I}_{1} - {I}_{A}}{{I}_{2} - {I}_{A}} \qquad ( 14 )$$

The discussion above describes how the components of diffuse reflection are handled in the calculations. Ambient specular reflections are also removed by the image subtraction operation in Equation (13). Specular reflections added by the supplemental lights are not removed, which is good, because those reflections can help reveal edges and other 3D features of the top of the subject 410. In the output image Q, the only variations on the top surface 412 that remain are those due to the angle between each point's surface normal and the direction of the light, which are due to variations (such as wrinkles, flap seams and box edges) in the 3D shape of the surface 412.

Many of the Equations (1) through (14) include image arithmetic—specifically, image subtraction and image division operations. Each of these operations is a pixel-by-pixel calculation using a pixel intensity value for each corresponding pair of pixels in the two images. The pixel intensity value for each pixel is an integer value in a predefined range such as 0-255, or 0-4095. Other pixel intensity value ranges may be used.

For example, consider an example where each image is 1000 pixels by 1000 pixels (1000 rows×1000 columns=1 million pixels). If Pixel 1 (Row 1, Column 1) has an intensity of 247 in a first image and the corresponding Pixel 1 in a second image has an intensity of 133, then when the second image is subtracted from the first image, Pixel 1 in the resultant image has an intensity of 114 (247−133). This calculation is performed for each pixel in each pair of images which are subtracted. The same pixel-by-pixel calculation concept applies to image division, where a pixel's intensity value in one image is divided by the intensity value of a corresponding pixel in another image.

Each of the images I_{A}, I₁ and I₂ are taken using equal exposure times. The exposure times are selected to be low enough to ensure that intensity values are not clipped for brightly colored pixels in any of the images (that is, the maximum intensity value of all pixels in all images should be less than the maximum value such as 255 or 4095).

Again, the same techniques could be applied to color images to remove 2D features if the same processing (Equation (14)) was done separately for the red, green, and blue channels. However, there would be no particular benefit to using color as the 3D features remaining in the image do not have different colors.

Using the techniques discussed above, the system 400 can be employed to capture images of the subject 410 which can be quickly processed to produce an output image which has been purged of colors and other 2D features, and is particularly suited to subsequent processing such as segmentation to identify true box edges and corners and thereby determine box shapes and sizes as is necessary for robotic box depalletizing operations.

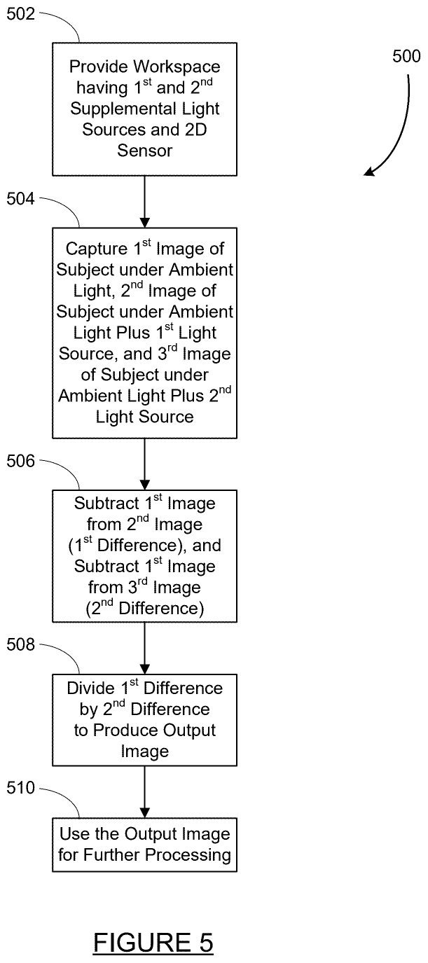

FIG. 5 is a flowchart diagram 500 of a method for obtaining images of a subject and processing the images to produce an output image which is devoid of intensity variations due to 2D features such as colors, graphics and tape, according to an embodiment of the present disclosure. At box 502, a workspace is provided as shown in FIG. 4, having the system 400 including the lights 420/422 and the 2D sensor 430. At least the sensor 430 communicates with the computer 440. The flowchart diagram 500 of FIG. 5 illustrates a general image analysis methodology, and as such, the specific orientations illustrated in FIG. 4 (horizontal top surface, downward aiming angles of lights and sensor/camera) should be considered to be merely non-limiting examples.

At box 504, three images of the subject 410 are captured using the sensor 430—including a first image I_{A} under ambient light only, a second image I₁ under ambient light plus the light 420, and a third image I₂ under ambient light plus the light 422. The images may be obtained in an entirely manual fashion (with the lights 420/422 and the sensor 430 manually controlled by switches/buttons), or in an entirely automated fashion (with operation of the lights 420/422 and the sensor 430 controlled by the computer 440), or any combination thereof. The images I_{A}, I₁ and I₂ are provided to the computer 440 for processing.

At box 506, image subtraction is performed as indicated in Equations (7) and (8) above, and also in the numerator and denominator of Equation (14). That is, a first intermediate image (representing the diffuse reflection due to the first supplemental light source) is computed as I₁−I_{A}, and a second intermediate image (representing the diffuse reflection due to the second supplemental light source) is computed as I₂−I_{A}. Subtracting the ambient image eliminates the components of ambient diffuse and specular reflections from the images I₁ and I₂.

At box 508, image division is performed as indicated in Equation (14) above. That is, one of the intermediate images computed at the box 506 is divided by the other. Dividing the first and second supplementally-lighted images (after ambient subtraction) eliminates color and other 2D surface features from the output image Q. The division may be performed with either the first or second supplementally-lighted image in the numerator and the other in the denominator, because which of the lights 420/422 corresponds to the image I₁ and which light corresponds to the image I₂ is after all a matter of arbitrary definition. This is discussed again below.

At box 510, the output image Q is used in further processing or analysis. For example, the output image Q is particularly well suited for a “segmentation” computation on a pallet of boxes, where individual boxes are identified by their edges, as the edges are plainly visible in the output image Q, while colors and 2D features are purged from the image Q.

It should be noted that FIG. 5 depicts the disclosed methodology in terms of very deliberate steps. In actual implementation, the planar purge technique can be executed in essentially two steps—capturing the images, and then computing the output image Q using Equation (14). When computing the output image Q, the intermediate images do not necessarily need to be computed at all. Instead, the output image Q may be computed directly by applying Equation (14) (two subtractions, followed by a division) to each pixel in one step.

The techniques discussed above have been developed and demonstrated in numerous experiments, and the elimination of colors and 2D features from planar surfaces has been shown to be very effective on a variety of subjects (top surfaces of pallets containing different styles and arrangements of boxes, in particular). Using the disclosed techniques, “elimination of colors” from the output image does not simply mean converting color to grayscale as would be done by a black and white camera. Rather, “elimination of colors” means completely purging all intensity variations due to colors and 2D features from the output image—as if there had been no colors, markings or 2D features on the subject to begin with. Three examples are shown and discussed below.

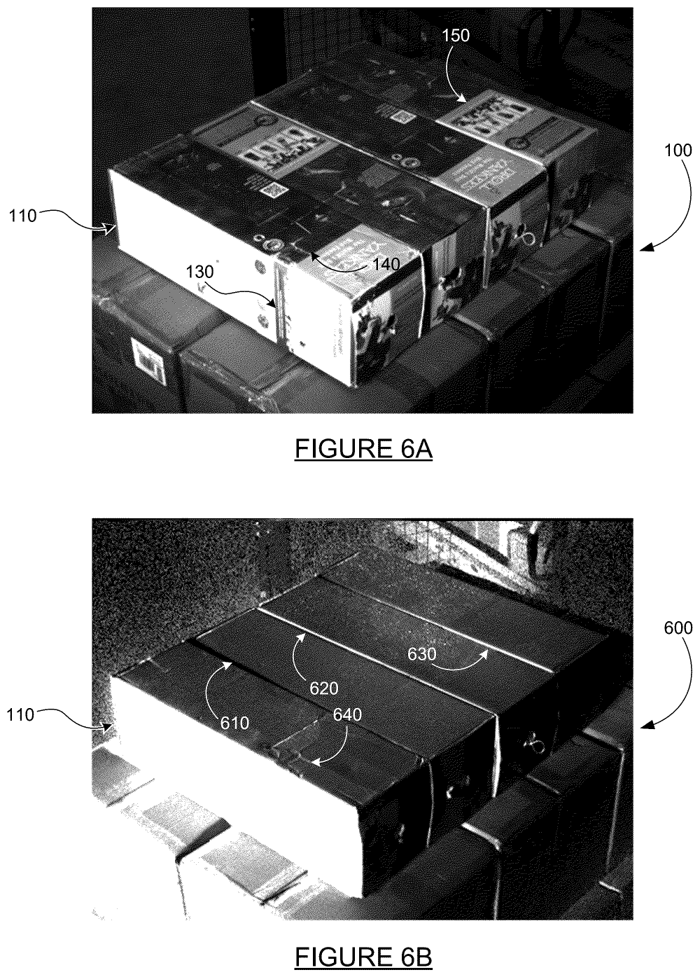

FIG. 6A is the image of the collection of boxes of FIG. 1, and FIG. 6B is a corresponding output image with planar features purged using the system of FIG. 4 and the method of FIG. 5. FIG. 6A is a recreation of the image 100 of FIG. 1 discussed above, with the upper layer 110 of boxes having many graphical design features on their surfaces—including the dark bar 130 and the light/dark transitions 140 and 150.

FIG. 6B is an image 600 created using the planar purge techniques disclosed above. Specifically, the image 600 is an output image Q, containing the same upper layer 110 of boxes, created using Equation (14) from a trio of input images I_{A}, I₁ and I₂. It is immediately noticeable in the image 600 that none of the graphical features (130, 140 and 150) of the boxes from the image 100 are visible at all. Thus, the problem of misidentifying box edges at the 2D features 130, 140 and 150 has been solved. In the image 600, only 3D box features are visible on the top surface of the upper layer 110 of boxes. Most of these 3D features are true box edges (610, 620 and 630) which are enhanced in visibility due to the image arithmetic techniques of the present disclosure. Some small dents in one of the boxes are also visible as indicated at 640. The image 600 illustrates how effectively the presently disclosed planar purge techniques eliminate 2D features and enhance 3D features in a subject. It is clear that the image 600 is far preferable to the image 100 for further analysis applications such as box segmentation.

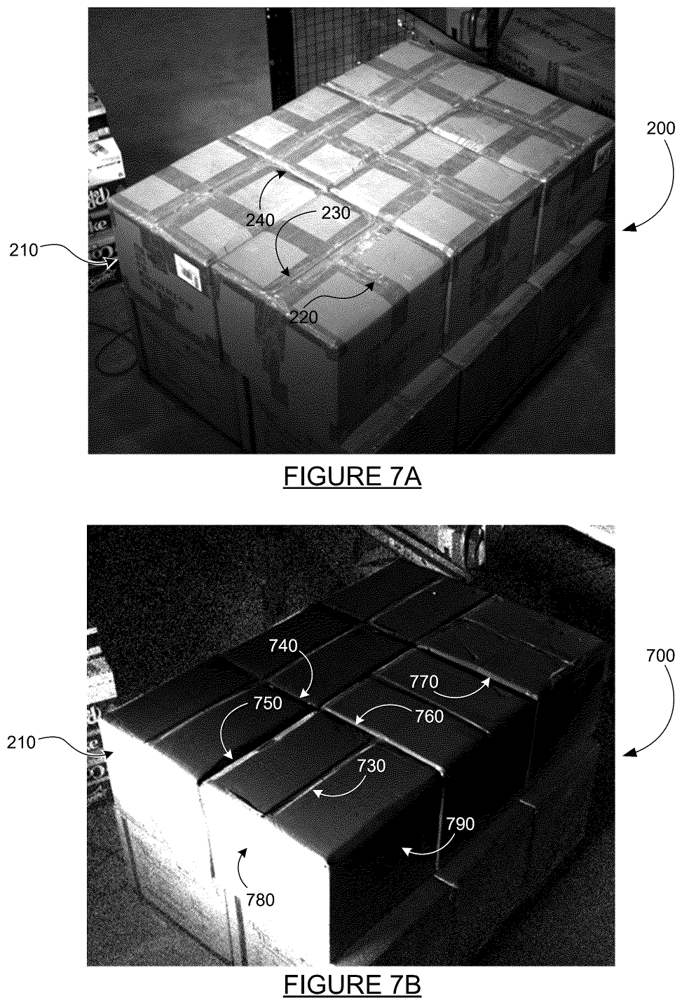

FIG. 7A is the image of the collection of boxes of FIG. 2, and FIG. 7B is a corresponding output image with planar features purged using the system of FIG. 4 and the method of FIG. 5. FIG. 7A is a recreation of the image 200 of FIG. 2 discussed above, with the upper layer 210 of boxes having a lot of 2D features (lightness and reflections) related to the transparent tape applied on their surfaces.

FIG. 7B is an image 700 created using the planar purge techniques disclosed above. Specifically, the image 700 is an output image Q, containing the same upper layer 210 of boxes, created using Equation (14) from a trio of input images I_{A}, I₁ and I₂. It is immediately noticeable in the image 700 that the transparent tape has disappeared—both the lightness/darkness effects and the specular reflections. Where the tape strip 220 was located in FIG. 7A, nothing at all (just plain cardboard) is visible in FIG. 7B. Where the tape strips 230 covered a flap seam in FIG. 7A, only a flap seam 730 itself (which has a 3D trough shape) is visible in FIG. 7B. Where the tape strips 240 were applied along box edges in FIG. 7A, those box edges are visible at 740 in FIG. 7B. Other box edges are also plainly visible in FIG. 7B, as indicated at 750, 760 and 770, for example. The image 700 illustrates again how effectively the presently disclosed planar purge techniques eliminate 2D features and enhance 3D features in a subject. It is clear that the image 700 is far preferable to the image 200 for further analysis applications such as box segmentation.

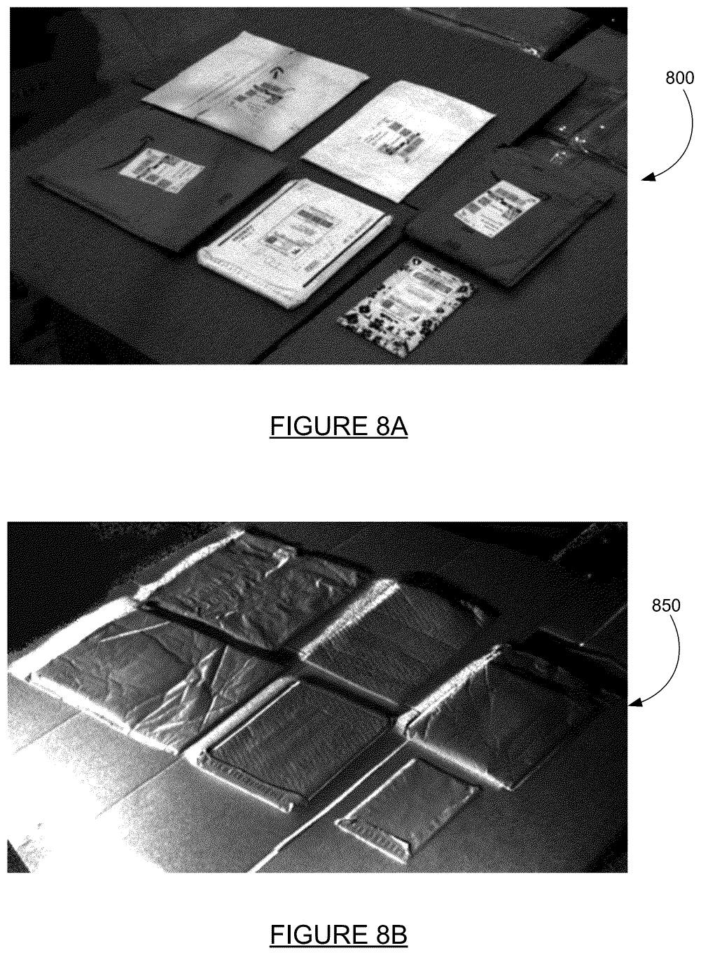

FIG. 8A is an image 800 of a collection of flat packages, and FIG. 8B is a corresponding output image 850 with planar features purged using the system of FIG. 4 and the method of FIG. 5. FIGS. 8A and 8B provide another clear and dramatic example of the effectiveness of the disclosed planar purge technique—where bright/white and dark/black packages appear the same in the output image 850, and labels, markings and other 2D features are absent from the output image 850. Again, the image 850 is far preferable to the image 800 for further processing such as package segmentation (identifying the edges of these flat packages).

Many other palletized stacks of boxes and other arrangements of packages have been studied using the planar purge techniques of the present disclosure, and have yielded equally dramatic results, eliminating all 2D features—such as but not limited to printing, graphics, labels, coloration, straps and tape—from the target surface of the boxes/packages, while enhancing 3D features such as actual box/package edges.

It was mentioned earlier that the division operation of Equation (14) may be performed with either the first or second supplementally-lighted image in the numerator and the other in the denominator. Reversing the numerator and denominator in Equation (14) (or reversing the light sources associated with the images I₁ and I₂) will have the effect of changing the intensity levels in the pixels of the output image Q, but in either case the output image Q will still be devoid of color effects and other 2D features, and the only 3D features will be apparent on the top surface 412 of the subject 410. FIG. 7B shows the output image Q based on a particular demonstration workspace setup with one supplemental light source associated with the image I₁ and the other supplemental light source associated with the image I₂. If the light sources or the image division were reversed, the effect would be that the near/left ends of the boxes (indicated by arrow 780) would be very dark instead of very bright, and the near/right sides of the boxes (indicated by arrow 790) would be very bright instead of very dark. The top face of the stack of boxes would still be essentially uniform in appearance except for the very visible box edges and flap seams.

The dramatic results apparent in FIGS. 6A/6B, 7A/7B and 8A/8B—with planar features purged and 3D features enhanced—are partially a result of thoughtful placement of the supplemental light sources. For example, in FIGS. 7A/7B, the supplemental lights would preferably be placed such that the aiming vector of one of the lights (e.g., the light 420) has a horizontal component which is perpendicular to one edge of the stack of boxes, and the aiming vector of the other one of the lights (e.g., the light 422) has a horizontal component which is perpendicular to an adjacent edge of the stack of boxes (90° clockwise or counter-clockwise as viewed from above). This arrangement provides the most dramatic bright reflection lines and dark shadow lines at the box edges, as visible in FIG. 7B. Other supplemental light source placements may be more suitable to other types of subjects—for example, where the boxes have shapes or stacking arrangements which result in box edges which are on diagonal angles relative to the pallet itself, the lights may be aligned with an aiming vector perpendicular to those diagonal edges.

As mentioned earlier, the system of FIG. 4 and the before-and-after images of FIGS. 6-8 have been provided to clearly explain and demonstrate the effectiveness of the planar purge technique applied to horizontal top surfaces. However, it is emphasized that the planar purge technique is applicable to any relatively flat surface—not just horizontal top surfaces. That is, the disclosed technique can be applied equally effectively to eliminate color and 2D features from vertical surfaces (e.g., sides of boxes) and oblique surfaces (faces of objects which are oddly shaped or positioned with surfaces which are neither horizontal nor vertical).

Consider for example the collection of boxes shown in FIGS. 7A and 7B. The disclosed planar purge techniques could be applied to produce an image of the near/left ends of the boxes (indicated by the arrow 780) which is devoid of colors and 2D features, rather than the top surface. To produce a planar purged image of the near/left ends of the boxes, it would simply be necessary to provide two supplemental light sources which both impinge on the near/left ends, capture the three images (I_{A}, I₁ and I₂), and compute the output image Q using Equation (14). The same concept is applicable to other vertical surfaces, and to oblique surfaces.

Continuing with the example of FIGS. 7A and 7B, it can readily be envisioned how an output image of the entire stack of boxes can be produced in which all of the surfaces have been purged of intensity variations due to colors and 2D features. This would be done by providing a plurality of supplemental light sources at different locations around the stack of boxes, capturing an ambient-light image (I_{A}), and then capturing pairs of supplementally-lighted images (I₁ and I₂) for each planar surface (e.g., top, near/left end, and near/right side). An output image Q can then be calculated for each of the three planar surfaces (top, near/left end, and near/right side) using the corresponding images, and a composite output image can then be produced which uses the planar purged images Q for each of the three planar surfaces. It can be easily envisioned how such a fully planar purged composite image would be most effective for use in 3D box segmentation of the entire stack of boxes.

All of the above discussion has been directed to eliminating colors and 2D features from images of planar surfaces. Using more advanced lighting, image capture and computational techniques, the same concepts can be applied to eliminate colors and 2D features from non-planar surfaces. Although it may not be practical to completely eliminate coloration effects for all surface orientation angles on arbitrarily shaped objects, in certain cases the disclosed techniques can yield a similar effect of reducing shading variations due to surface coloration while not affecting those due to 3D shape. Thus, it can be summarized that the disclosed image processing techniques can be used to reduce the shading variations in output images for objects of any shape, and the techniques work particularly well for images of flat planar surfaces, where the intensity variations in an image due to colors and 2D features can be eliminated completely.

The disclosed planar purge techniques describe a general imaging method. Although the examples provided and discussed above illustrate the application of the method to box segmentation in an industrial setting, many other applications are envisioned. For example, the disclosed techniques could be applied to other computer vision and non-computer vision applications, including but not limited to:
Visual surface inspection using computer vision.
An imaging device to enhance the appearance of surfaces for human inspection
Artistic effects for photographic imaging
Special effects for film making.
Applications with cameras and lights that use non-visible wavelengths of radiation such as infrared or ultraviolet, so that the flashing lights are not visible to human observers
Outdoor imaging for camouflage removal or reduction:
   Corporate intelligence gathering: imaging prototype cars and trucks with camouflage paint jobs and removing or reducing the camouflage to afford clearer visibility of their shape
   Military surveillance: imaging camouflaged soldiers and vehicles outdoors using fixed or aerial drone carried infrared cameras and lights and producing an image with removed or reduced camouflage for enhanced visibility

Throughout the preceding discussion, various image arithmetic operations are described and implied. It is to be understood that these calculations may be performed in software applications and modules of a computer such as the computer 440 of FIG. 4. The computer 440, which includes one or more processor and memory, along with input/output ports, etc., receives and processes the input images from the sensor 430, provides the output image resulting from Equation (14), and may also control the sensor 430 and the lights 420/422. The computer 440 may also be a robot controller—that is, the controller of the robot which is performing the box depalletizing operation. In such an embodiment, the sensor 430 provides its images/data directly to the robot controller which performs the image arithmetic, and no additional computer is necessary.

As outlined above, the disclosed embodiments of planar feature purging from 2D images provide significant advantages over existing image processing methods, and provide an output image of a subject which is essentially devoid of 2D features including color on a top surface, where the output image is suitable for direct human viewing and/or for further computer processing such as the box segmentation application.

While a number of exemplary aspects and embodiments of a method and system for eliminating 2D features from planar surfaces and accentuating 3D features in 2D images have been discussed above, those of skill in the art will recognize modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method for eliminating two-dimensional (2D) features from an image, said method comprising:
providing a workspace with a single 2D sensor at a fixed location and pose, and first and second supplemental light sources fixed at different locations from each other;
providing, by the 2D sensor, a first input image of a subject under ambient lighting, a second input image of the subject under the ambient lighting plus the first supplemental light source, and a third input image of the subject under the ambient lighting plus the second supplemental light source; and
computing an output image having the 2D features eliminated, on a computer having a processor and memory, by subtracting the first input image from the second input image to produce a first difference, subtracting the first input image from the third input image to produce a second difference, and dividing the first difference by the second difference.

2. The method according to claim 1 wherein the 2D sensor is a 2D camera.

3. The method according to claim 1 wherein the subject has a flat surface from which the 2D features are eliminated in the output image.

4. The method according to claim 3 wherein the 2D sensor is aimed either perpendicularly or at an oblique angle toward the flat surface.

5. The method according to claim 3 wherein the supplemental light sources are aimed at oblique angles toward the flat surface.

6. The method according to claim 1 wherein subtracting the first input image from the second input image and subtracting the first input image from the third input image include subtracting a pixel intensity value on a corresponding pixel-by-pixel basis, and where dividing the first difference by the second difference includes dividing the pixel intensity value on a corresponding pixel-by-pixel basis.

7. The method according to claim 6 wherein computing the output image includes computing a first intermediate image by subtracting a portion or an entirety of the first input image from a corresponding portion or entirety of the second input image, and computing a second intermediate image by subtracting the portion or the entirety of the first input image from a corresponding portion or entirety of the third input image, then computing the output image by dividing the first intermediate image by the second intermediate image.

8. The method according to claim 6 wherein computing the output image includes computing the first and second differences and dividing the first difference by the second difference for each pixel of the output image.

9. The method according to claim 1 wherein the subject is a plurality of boxes arranged on a pallet, and further comprising using the output image in a box segmentation computation, where edges of the boxes are identified in the output image, and sizes and shapes of individual boxes are determined from the edges.

10. The method according to claim 1 wherein the subject is a plurality of flat packages arranged on a surface, and further comprising using the output image in a package finding computation, where edges of the packages are identified in the output image, and sizes and shapes of individual packages are determined from the edges.

11. The method according to claim 1 wherein the subject has curved surfaces from which the 2D features are removed in the output image, where a plurality of supplemental light sources are provided in the workspace, and a plurality of input images are used to selectively remove the 2D features from localized portions of the output image.

12. The method according to claim 1 wherein the subject has a plurality of flat surfaces, where a plurality of supplemental light sources are provided in the workspace, and where a plurality of input images are used to selectively remove the 2D features from each of the flat surfaces in a separate output image, and the separate output images are combined in a composite output image having the 2D features eliminated from each of the flat surfaces.

13. The method according to claim 1 wherein the 2D features which are eliminated from the output image include intensity variations due to colors, markings, graphics and tape.

14. A method for eliminating two-dimensional (2D) features from an image, said method comprising:
providing, by a 2D sensor, a first input image of a subject under ambient lighting, a second input image of the subject under the ambient lighting plus a first supplemental light source, and a third input image of the subject under the ambient lighting plus a second supplemental light source; and
computing an output image having the 2D features eliminated, on a computer having a processor and memory, by subtracting the first input image from the second input image to produce a first difference, subtracting the first input image from the third input image to produce a second difference, and dividing the first difference by the second difference.

15. A system for eliminating two-dimensional (2D) features from an image of a subject, said method comprising:
a 2D sensor in a fixed position and pose aimed at the subject;
first and second supplemental light sources in different fixed positions aimed at the subject; and
a computer having a processor and memory, said computer being in communication with the 2D sensor and configured to;
receive from the 2D sensor a first input image of the subject under ambient lighting, a second input image of the subject under the ambient lighting plus the first supplemental light source, and a third input image of the subject under the ambient lighting plus the second supplemental light source, and
compute an output image having the 2D features eliminated by subtracting the first input image from the second input image to produce a first difference, subtracting the first input image from the third input image to produce a second difference, and dividing the first difference by the second difference.

16. The system according to claim 15 wherein the 2D sensor is a 2D camera.

17. The system according to claim 15 wherein the subject has a flat surface from which the 2D features are eliminated in the output image.

18. The system according to claim 17 wherein the 2D sensor is aimed either perpendicularly or at an oblique angle toward the flat surface.

19. The system according to claim 17 wherein the supplemental light sources are aimed at oblique angles toward the flat surface.

20. The system according to claim 15 wherein subtracting the first input image from the second input image and subtracting the first input image from the third input image include subtracting a pixel intensity value on a corresponding pixel-by-pixel basis, and where dividing the first difference by the second difference includes dividing the pixel intensity value on a corresponding pixel-by-pixel basis.

21. The system according to claim 20 wherein computing the output image includes computing a first intermediate image by subtracting a portion or an entirety of the first input image from a corresponding portion or entirety of the second input image, and computing a second intermediate image by subtracting the portion or the entirety of the first input image in from a corresponding portion or entirety of the third input image, then computing the output image by dividing the first intermediate image by the second intermediate image.

22. The system according to claim 20 wherein computing the output image includes computing the first and second differences and dividing the first difference by the second difference for each pixel of the output image.

23. The system according to claim 15 wherein the computer controls the 2D sensor and the supplemental light sources to automatically capture the first, second and third input images.

24. The system according to claim 15 wherein the subject is a plurality of boxes arranged on a pallet, and the output image is used in a box segmentation computation, by the computer or by a different computer, where edges of the boxes are identified in the output image, and sizes and shapes of individual boxes are determined from the edges.
